(19) United States
(12) Patent Application Publication
(10) Pub. No.: US 2018/0074279 A1
(43) Pub. Date: Mar. 15, 2018

(54) STRUCTURE OF DUAL-LENS WITH MECHANIC ZERO TILT ANGLE AND ADJUSTMENT METHOD THEREOF

(71) Applicant: TOPRAY MEMS INC., Hsinchu City (TW)

(72) Inventors: Chin-Sung Liu, Hsinchu City (TW); Shin-Ter Tsai, Hsinchu City (TW); Tsung-Min Yang, Hsinchu City (TW); Chi-Ling Chang, Hsinchu City (TW)

(21) Appl. No.: 15/344,607

(22) Filed: Nov. 7, 2016

(30) Foreign Application Priority Data
Sep. 12, 2016 (TW) 105129608

(51) Int. Cl. G02B 7/02; H02K 41/035; H02K 15/16

(52) U.S. Cl. CPC G02B 7/023; H02K 15/16; H02K 41/0356

(57) ABSTRACT

A dual-lens mechanic zero tilt angle adjustment method is disclosed, comprising a preparation step, an adjustment step and an engagement step, wherein preparation step comprising: disposing a dual-lens at one or two voice coil motors (VCM), with the dual-lens having optical axes respectively unparallel to the normal of the plane of an adaptor, and the optical axes forming a first and second tilt angles with the normal of the adaptor plane; adjustment step comprising: adjusting the first and second tilt angles by moving VCM to zero degree; and engagement step comprising: adhering the bottom of VCM to an engagement surface of adaptor to obtain a structure of dual-lens mechanic zero tilt angle. As such, the adaptor plane is engaged to the image sensor, and the tilt angles between the optical axes of dual-lens and the axis of the image sensor are both zero to improve imaging quality.

### CROSS-REFERENCE TO RELATED APPLICATION

The present application is based on, and claims priority form, Taiwan Patent Application No. 105129608, filed Sep. 12, 2016, the disclosure of which is hereby incorporated by reference herein in its entirety.

### TECHNICAL FIELD

The technical field generally relates to a structure of dual-lens and adjustment method thereof, and in particular, to a dual-lens structure with optical axes forming zero tilt angle with the axis of the mage sensor simultaneously, and adjustment method thereof

### BACKGROUND

As the mobile phone with camera become ubiquitous, the consumers demand ever-increasing higher image quality. The improvement in the quality of imaging comes from the design and manufacturing technology, wherein the relative angle offset (i.e., tilt angle) between the optical axes of a dual-lens structure becomes a key factor in the quality of imaging.

Refer to FIG. 1 and FIG. 2. FIG. 1 shows a schematic view of a voice coil motor of a known dual-lens structure, and FIG. 2 shows a dissected view of a voice coil motor of a known dual-lens structure. The conventional dual-lens structure comprises two voice coil motors 1 (with the figures showing only one of the two voice coil motors), two lenses (not shown), and a image sensor (not shown). Each voice coil motor comprises an outer cover 1A, an upper resilient stripe 1B, a magnet 1C, a coil 1D, a base 1E, a lower resilient stripe 1F and a lower cover 1G. The two lenses are disposed respectively to the base 1E of each voice coil motor 1. The image sensor and the lower covers 1G of the two voice coil motors 1 are engaged together.

However, because each component of the voice coil motor has a tolerance, and the assembled voice coil motor generates a tolerance stack up, the tolerances and the tolerance stack up cause the optical axes of the two lenses non-perpendicular to the bottom surface of the lower cover 1G of the two voice coil motors 1. Hence, after the image sensor is engaged to the bottom surface of the lower cover 1G of the two voice coil motors 1, the optical axes of the two lenses form a tilt angle and are unable to become parallel to the axis of the image sensor, which reduces the imaging quality of the image sensor. Even worse, the tilt angles formed between the two optical axes and the axis of the image sensor differ from each other, resulting further degradation the imaging quality.

The conventional solution is to improve the precision of the components and reduce the tolerance of each component and the tolerance stack up after assembly, so as to reduce the tilt angle to improve imaging quality.

Although the new precision machinery technologies can improve the component precision, it is still difficult to achieve a complete precision for each component in mass production process. The reason lies in the machine vibration, material variation, abrasion of tools, temperature variation, residual stress in components, and so on. Therefore, however the precision improves, a zero-tolerance for each component is simply unachievable, not to mention the tolerance stack up after assembly. In other words, the probability of achieving zero tilt angles between the two optical axes and the axis of the image sensor is very low and the conventional solution shows limitations. Moreover, the precision improvement often takes longer time to achieve, as well as incurring higher production costs.

### SUMMARY

The primary object of the present invention is to provide a adjustment method for a dual-lens structure with mechanic zero tilt angle, for adjusting the first tilt angle and the second tilt angle between the optical axes of the dual-lens and the normal of the adaptor plane to 0° so that the optical axes of dual-lens are parallel to the axis of the image sensor to achieve zero tilt angles simultaneously between the optical axes of the dual-lens and the axis of the image sensor to improve imaging quality. The adjustment method provides ease to use, high efficiency and low production cost.

Another object of the present invention is to provide a dual-lens structure with mechanic zero tilt angle, with the optical axes of the dual-lens perpendicular to the normal of the adaptor plane so that the optical axes of dual-lens are parallel to the axis of the image sensor to achieve zero tilt angles simultaneously between the optical axes of the dual-lens and the axis of the image sensor to improve imaging quality. The structure provides ease in structure, high efficiency and low production cost.

To achieve the aforementioned object, the present invention provides an adjustment method for dual-lens structure with mechanic zero tilt angle, comprising the steps of: a preparation step: disposing two lenses of the dual-lens structure respectively at two voice coil motors (VCM), with bottom surfaces of the two VCMs maintaining a distance to an engagement surface of an adaptor, the two optical axes of the two lenses unparallel to each other and the normal of a reference plane of the adaptor so that the optical axes forming a first and second tilt angles with the normal of the reference plane of the adaptor; an adjustment step: moving at least one of the two VCMs and the adaptor to adjust the first and second tilt angles to 0°, the optical axes of the two lenses being perpendicular to the reference plane of the adaptor and the at least one of the two VCMs and the adaptor stopping moving; and an engagement step: adhering the bottoms of the VCMs to the engagement surface of the adaptor.

Preferably, the adjustment step comprises: a first adjustment: moving one of the VCMs to make the optical axes of the two lenses parallel; and a second adjustment: moving the two VCMs simultaneously to adjust the first and the second tilt angles to 0°.

Preferably, a sensor is used for sensing the first and the second tilt angles; when the sensor sensing that the first and the second tilt angles becoming 0°, the at least one of the two VCMs and the adaptor stops moving.

Preferably, the adaptor is disposed on a surface of a work table, with two mechanical arms moving the two VCMs and the sensor disposed at the work table; and when the sensor sensing that the first and the second tilt angles becoming 0°, the two mechanical arms stop moving the two VCMs.

Preferably, an adhesive glue is disposed at the bottoms of the two VCMs and the engagement surface of the adaptor to form an adhesive layer.

Preferably, the adhesive glue is applied by coating on the bottoms of the two VCMs and the engagement surface of the adaptor.

To achieve the aforementioned objects, the present invention provides an adjustment method for dual-lens structure with mechanic zero tilt angle, comprising the steps of: a preparation step: disposing two lenses of the dual-lens structure at a voice coil motor (VCM), with a bottom surface of the VCM maintaining a distance to an engagement surface of an adaptor, the two optical axes of the two lenses being parallel to each other but unparallel to the normal of a reference plane of the adaptor so that the optical axes forming a first and second tilt angles with the normal of the reference plane of the adaptor; an adjustment step: moving the VCM and/or the adaptor to adjust the first and second tilt angles to 0°, the optical axes of the two lenses being perpendicular to the reference plane of the adaptor and the VCM and/or the adaptor stopping moving; and an engagement step: adhering the bottom of the VCM to the engagement surface of the adaptor.

Preferably, a sensor is used for sensing the first and the second tilt angles; when the sensor sensing that the first and the second tilt angles becoming 0°, the VCM and/or the adaptor stops moving.

Preferably, the adaptor is disposed on a surface of a work table, with a mechanical arm moving the VCM and the sensor disposed at the work table; and when the sensor sensing that the first and the second tilt angles becoming 0°, the mechanical arm stops moving the VCM.

Preferably, the adaptor is disposed on a surface of a work table, with a mechanical arm moving the adaptor and the sensor disposed at the work table; and when the sensor sensing that the first and the second tilt angles becoming 0°, the mechanical arm stops moving the adaptor.

Preferably, an adhesive glue is disposed at the bottom of the VCM and the engagement surface of the adaptor to form an adhesive layer.

Preferably, the adhesive glue is applied by coating on the bottom of the VCM and the engagement surface of the adaptor.

The present invention provides the following advantages: regardless of the tolerance of each component and the tolerance stack up of the assembled VCM, the adjustment method for dual-lens structure with mechanic zero tilt angle of the present invention can adjust the first and the second tilt angles to 0°, so that the optical axes of the two lenses are accurately perpendicular to the reference plane of the adaptor and the optical axes of two lenses are accurately parallel to the normal of the reference plane of the adaptor. At this point, the reference plane of the adaptor is engaged to an image sensor, the normal of the reference plane of the adaptor overlaps the axis of the image sensor so that the optical axes of the two lenses are parallel to the axis of the image sensor. As such, the present invention can achieve the object of reducing the tilt angles between the optical axes of the two lenses and the axis of the image sensor to 0°, which improves the imaging quality of the image sensor. The adjustment method is simple, efficient and low cost.

To achieve the aforementioned objects, the present invention provides a dual-lens structure with mechanic zero tilt angle, comprising: two lenses, two voice coil motors (VCM) and an adaptor; wherein each of the two lenses having an optical axis, each of the two VCMs having a bottom, and the two lenses being disposed at the two VCMs respectively; the adaptor having an engagement surface and a reference plane, with the bottoms of the two VCMs engaged respectively to the engagement surface of the adaptor, and the optical axes of the two lenses being perpendicular to the reference plane of the adaptor respectively.

Preferably, the dual-lens structure further comprises an adhesive layer, disposed between the bottoms of the two VCMs and the engagement surface of the adaptor.

To achieve the aforementioned objects, the present invention provides a dual-lens structure with mechanic zero tilt angle, comprising: two lenses, a voice coil motor (VCM) and an adaptor; wherein each of the two lenses having an optical axis, the VCM having a bottom, and the two lenses being disposed at the VCM; the adaptor having an engagement surface and a reference plane, with the bottom of the VCM engaged to the engagement surface of the adaptor, and the optical axes of the two lenses being perpendicular to the reference plane of the adaptor respectively.

Preferably, the dual-lens structure further comprises an adhesive layer, disposed between the bottom of the VCM and the engagement surface of the adaptor.

The present invention provides the following advantages: regardless of the tolerance of each component and the tolerance stack up of the assembled VCM, the dual-lens structure with mechanic zero tilt angle of the present invention can achieve the object that the optical axes of the two lenses are accurately perpendicular to the reference plane of the adaptor and the optical axes of two lenses are accurately parallel to the normal of the reference plane of the adaptor. At this point, the reference plane of the adaptor is engaged to an image sensor, the normal of the reference plane of the adaptor overlaps the axis of the image sensor so that the optical axes of the two lenses are parallel to the axis of the image sensor. As such, the present invention can achieve the object of reducing the tilt angles between the optical axes of the two lenses and the axis of the image sensor to 0°, which improves the imaging quality of the image sensor. The structure is simple and low cost.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a voice coil motor of a known dual-lens structure;

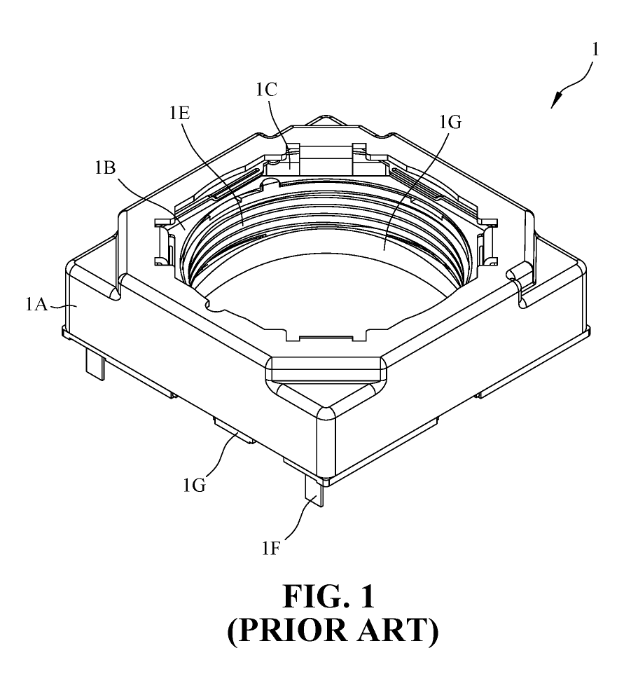

FIG. 2 shows a dissected view of a voice coil motor of a known dual-lens structure;

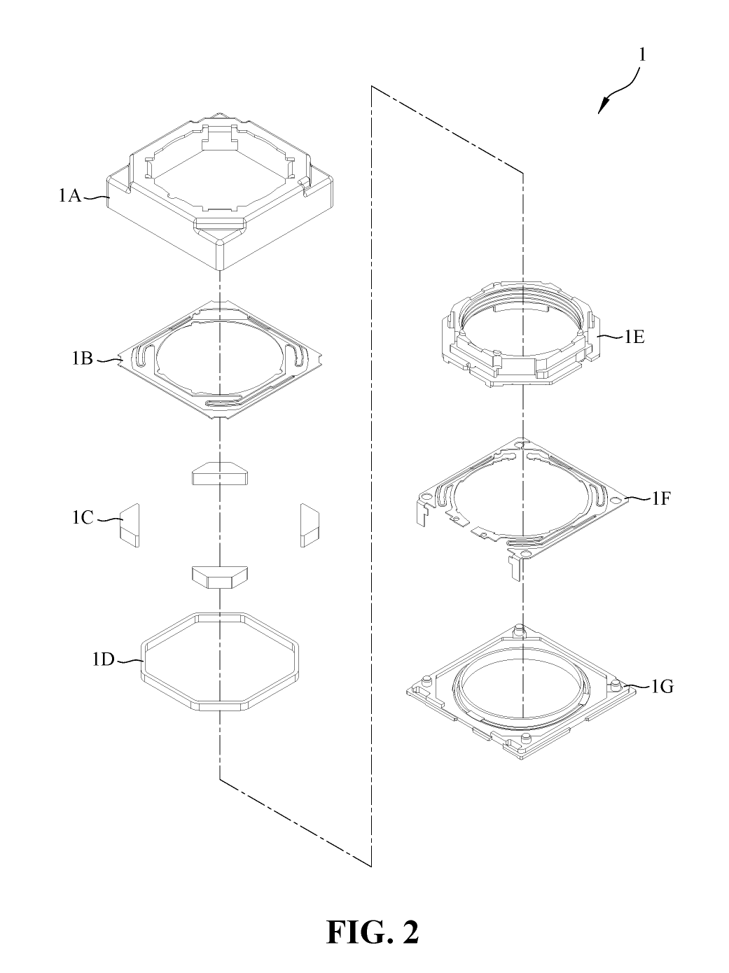

FIG. 3 shows a schematic view of the flowchart of the first embodiment of the adjustment method for dual-lens structure with mechanic zero tilt angle of the present invention;

FIG. 4A shows a schematic view of the preparation step of the first embodiment of the adjustment method for dual-lens structure with mechanic zero tilt angle of the present invention;

FIG. 4B shows a schematic view of the first adjustment sub-step of the adjustment step of the first embodiment of the adjustment method for dual-lens structure with mechanic zero tilt angle of the present invention;

FIG. 4C shows a schematic view of the second adjustment sub-step of the adjustment step of the first embodiment of the adjustment method for dual-lens structure with mechanic zero tilt angle of the present invention;

FIG. 4D shows a schematic view of the engagement step of the first embodiment of the adjustment method for dual-lens structure with mechanic zero tilt angle of the present invention;

FIG. 5 shows a schematic view of the first embodiment of the dual-lens structure with mechanic zero tilt angle of the present invention;

FIG. 6 shows a dissected view of the first embodiment of the dual-lens structure with mechanic zero tilt angle of the present invention;

FIG. 7 shows a schematic view of an image sensor engaged to the first embodiment of the dual-lens structure with mechanic zero tilt angle of the present invention;

FIG. 8 shows a schematic view of the flowchart of the second embodiment of the adjustment method for dual-lens structure with mechanic zero tilt angle of the present invention;

FIG. 9A shows a schematic view of the preparation step of the second embodiment of the adjustment method for dual-lens structure with mechanic zero tilt angle of the present invention;

FIG. 9B shows a schematic view of the adjustment step of the second embodiment of the adjustment method for dual-lens structure with mechanic zero tilt angle of the present invention;

FIG. 9C shows a schematic view of the engagement step of the second embodiment of the adjustment method for dual-lens structure with mechanic zero tilt angle of the present invention;

FIG. 10 shows a schematic view of the second embodiment of the dual-lens structure with mechanic zero tilt angle of the present invention;

FIG. 11 shows a dissected view of the second embodiment of the dual-lens structure with mechanic zero tilt angle of the present invention; and

FIG. 12 shows a schematic view of an image sensor engaged to the second embodiment of the dual-lens structure with mechanic zero tilt angle of the present invention.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

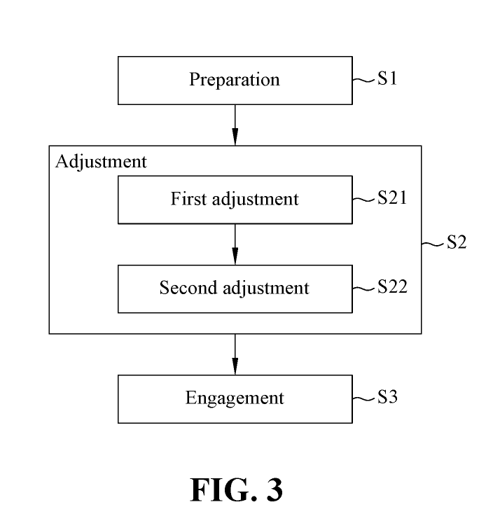

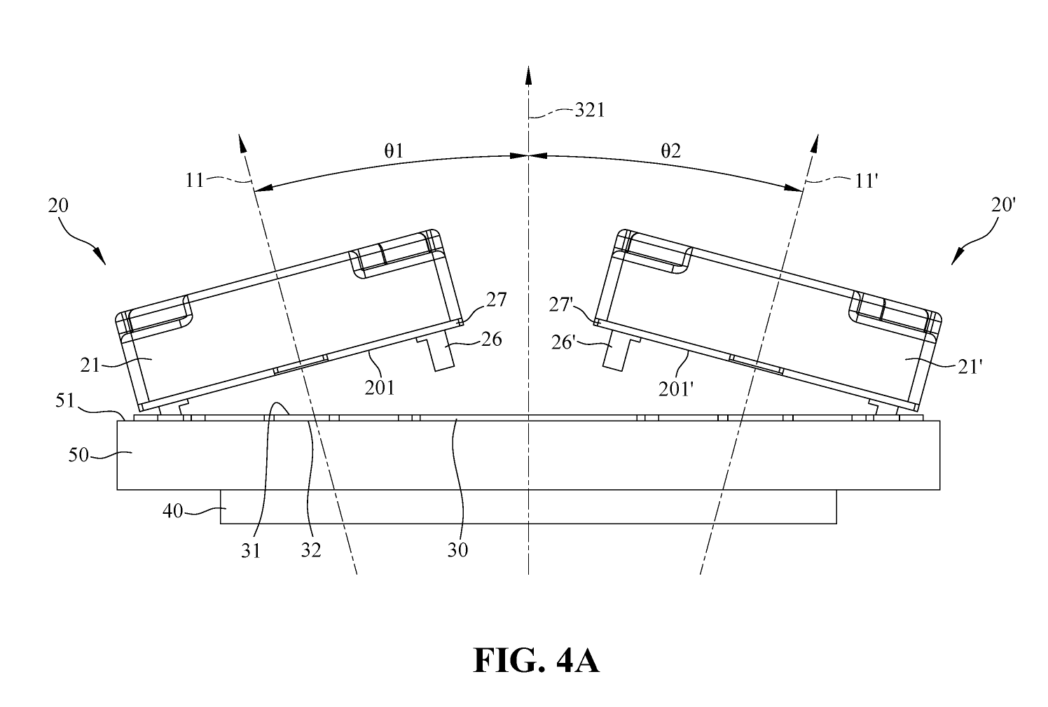

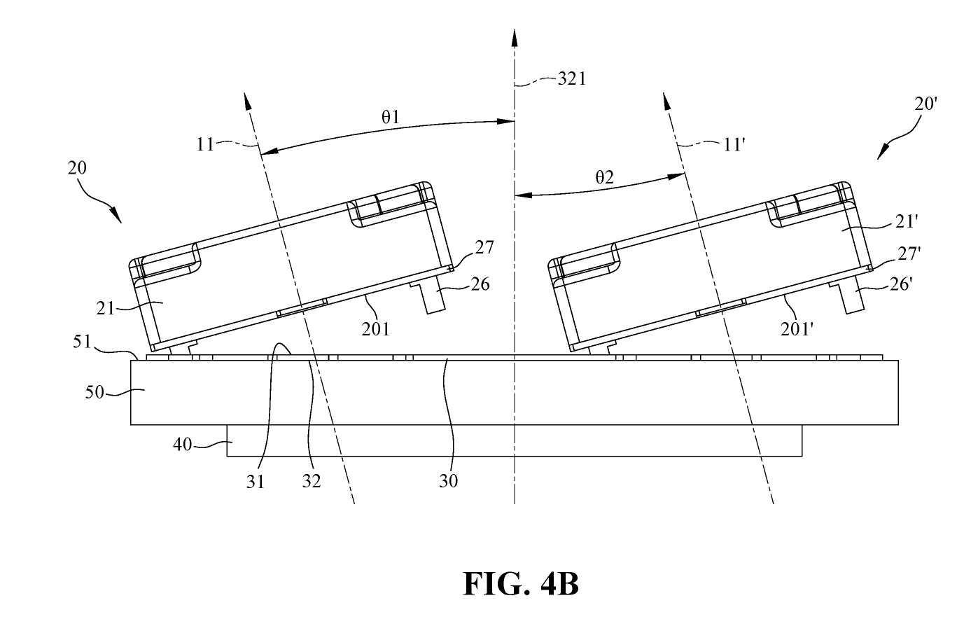

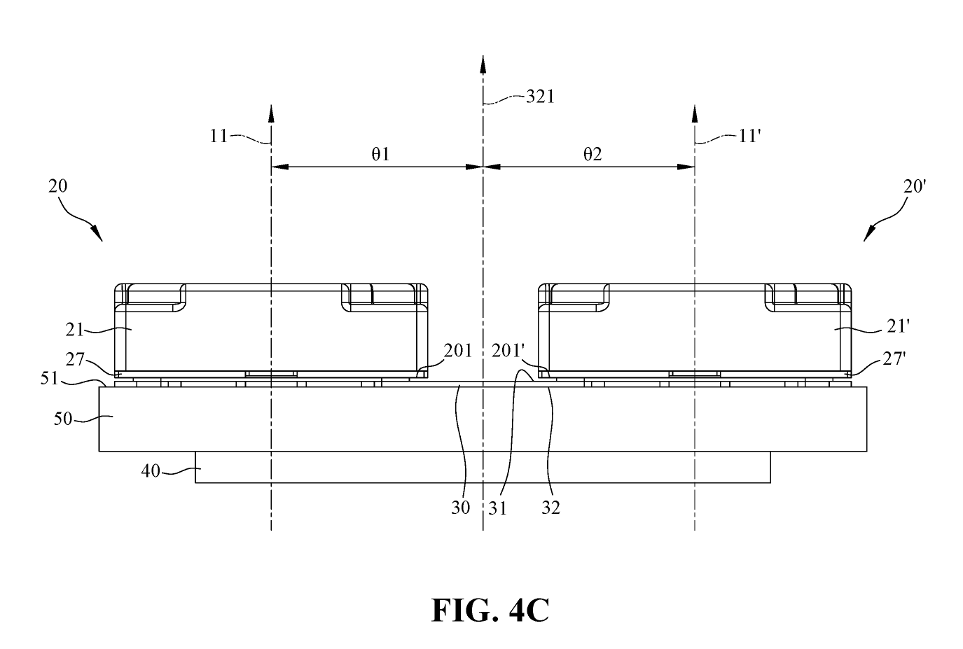

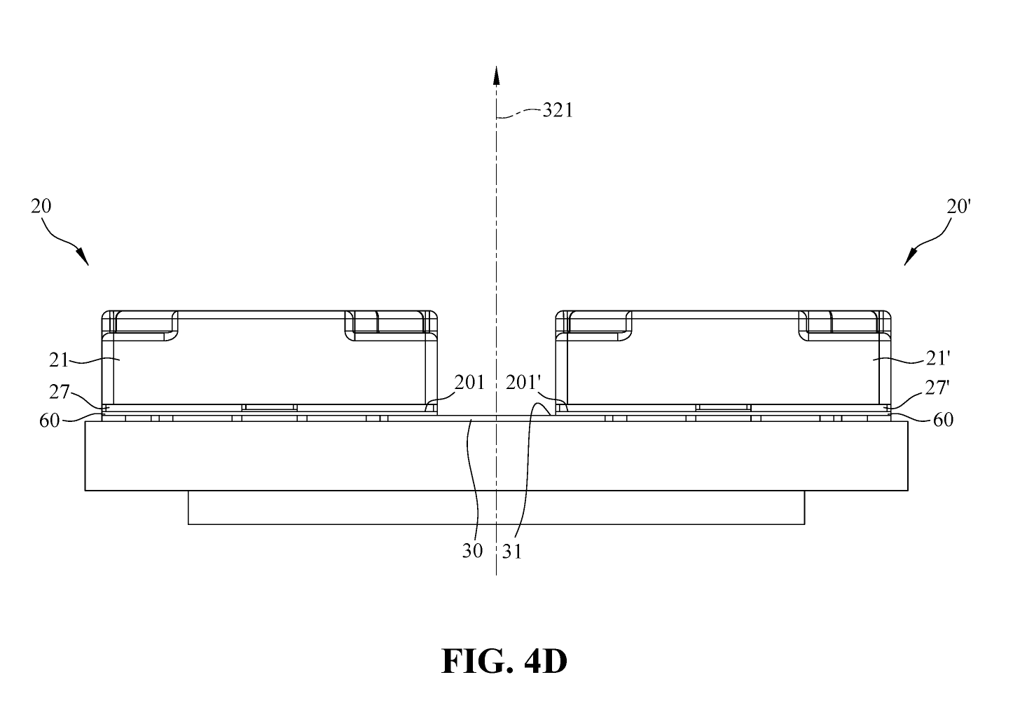

Refer to FIG. 3 and FIGS. 4A-4D. FIG. 3 shows a schematic view of the flowchart of the first embodiment of the adjustment method for dual-lens structure with mechanic zero tilt angle of the present invention; FIG. 4A shows a schematic view of the preparation step of the first embodiment of the adjustment method for dual-lens structure with mechanic zero tilt angle of the present invention; FIG. 4B shows a schematic view of the first adjustment sub-step of the adjustment step of the first embodiment of the adjustment method for dual-lens structure with mechanic zero tilt angle of the present invention; FIG. 4C shows a schematic view of the second adjustment sub-step of the adjustment step of the first embodiment of the adjustment method for dual-lens structure with mechanic zero tilt angle of the present invention; and FIG. 4D shows a schematic view of the engagement step of the first embodiment of the adjustment method for dual-lens structure with mechanic zero tilt angle of the present invention. The first embodiment of the adjustment method for dual-lens structure with mechanic zero tilt angle comprises the steps of:

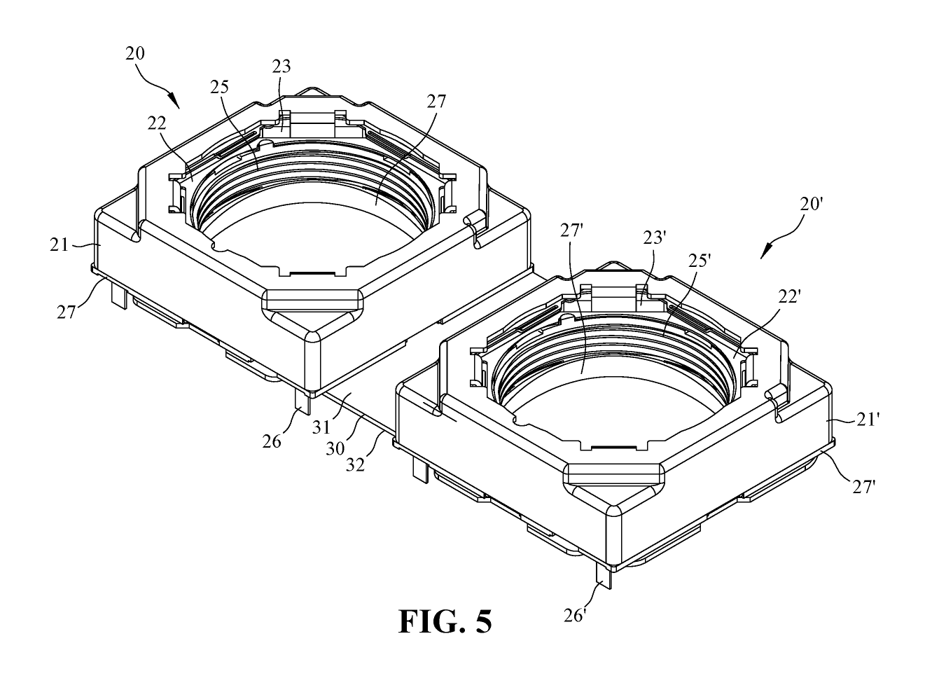

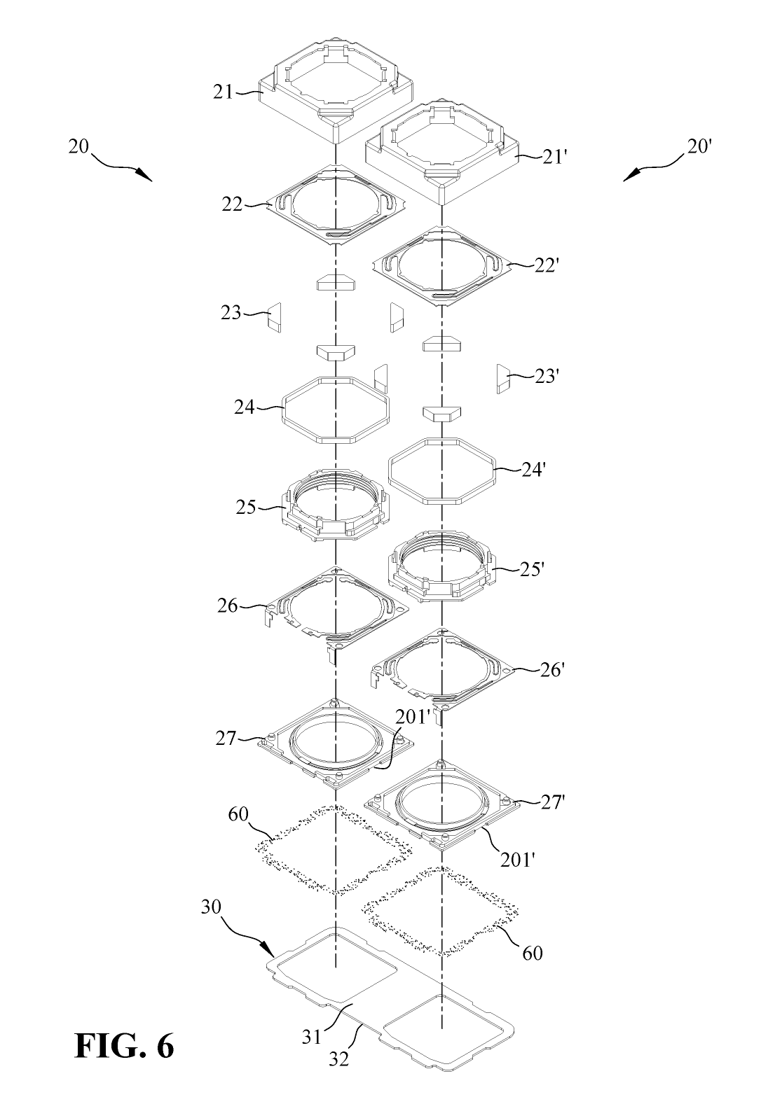

Preparation S1: disposing two lenses (not shown) of the dual-lens structure respectively at two voice coil motors (VCM) 20, 20′, with bottom surfaces 201, 201′ of the two VCMs 20, 20′ maintaining a distance to an engagement surface 31 of an adaptor 30, the two optical axes 11, 11′ of the two lenses unparallel to each other and the normal 321 of a reference plane 32 of the adaptor 30 so that the optical axes 11, 11′ forming a first and second tilt angles θ1, θ2 with the normal 321 of the reference plane 32 of the adaptor 30, as shown in FIG. 3 and FIG. 4A. Specifically, each VCM 20, 20′ comprises an outer cover 21, 21′, an upper resilient stripe 22, 22′, four magnets 23, 23′, a coil 24, 24′, a base 25, 25′, a lower resilient stripe 26, 26′ and a lower cover 27, 27′. The bottom of the lower cover 27, 27′ is defined as the bottom 201, 201′ of the VCM 20, 20′, as shown in FIG. 5 and FIG. 6. Because the VCM 20, 20′ and the components are of known technology, the connection and function of the components will not be described here.

Adjustment S2: moving at least one of the two VCMs 20, 20′ and the adaptor 30 to adjust the first and second tilt angles θ1, θ2 to 0°; when the first and second tilt angles θ1, θ2 being adjusted to 0°, the optical axes 11, 11′ of the two lenses being perpendicular to the reference plane 32 of the adaptor 30 and the at least one of the two VCMs 20, 20′ and the adaptor 30 stopping moving, as shown in FIG. 3, FIGS. 4B-4C. In other words, the first and second tilt angles θ1, θ2 being 0° means that the optical axes 11, 11′ of the two lenses are parallel to the normal 321 of the reference plane 32 of the adaptor 30. The moving refers to the motion in the six degrees of freedom in the three dimensional space, that is, an object moving along the X-axis, Y-axis and Z-axis, and rotating around the X-axis, Y-axis and Z-axis. Accordingly, in this step, the at least one of the two VCMs 20, 20′ and the adaptor 30 moves along the X-axis, Y-axis and Z-axis, and rotates around the X-axis, Y-axis and Z-axis so as to adjust the first and second tilt angles θ1, θ2. In the present embodiment, the adjustment S2 further comprises a first adjustment S21 and a second adjustment S22. The first adjustment S21 is: moving one of the VCMs 20′ to make the optical axes 11, 11′ of the two lenses parallel, as shown in FIG. 3 and FIG. 4B; and the second adjustment S22 is: moving the two VCMs 20, 20′ simultaneously to adjust the first and the second tilt angles θ1, θ2 to 0°, as shown in FIG. 3 and FIG. 4C. Preferably, a sensor 40 is used for sensing the first and the second tilt angles θ1, θ2; when the sensor 40 sensing that the first and the second tilt angles θ1, θ2 becoming 0° (i.e., the optical axes 11, 11′ of the two lenses are perpendicular to the reference plane 32 of the adaptor 30, and the optical axes 11, 11′ of the two lenses are parallel to the normal 321 of the reference plane 32 of the adaptor 30), the sensor 40 will propagate the sensing result to a control device (not shown), and the control device will control the at least one of the two VCMs 20, 20′ and the adaptor 30 to stop moving. As such, the optical axes 11, 11′ of the two lenses maintains in a state of being perpendicular to the reference plane 32 of the adaptor 30. In the present embodiment, the adaptor 30 is disposed on a surface 51 of a work table 50, with two mechanical arms (not shown) moving the two VCMs 20, 20′ and the sensor 40 disposed at the work table 50; and when the sensor 40 sensing that the first and the second tilt angles θ1, θ2 becoming 0° (i.e., the optical axes 11, 11′ of the two lenses are perpendicular to the reference plane 32 of the adaptor 30, and the optical axes 11, 11′ of the two lenses are parallel to the normal 321 of the reference plane 32 of the adaptor 30), the sensor 40 will propagate the sensing result to a control device, and the control device will control the two mechanical arms to stop moving the at least one of the two VCMs 20, 20′.

Engagement S3: adhering the bottoms 201, 201′ of the VCMs 20, 20′ to the engagement surface 31 of the adaptor 30, as shown in FIG. 3 and FIG. 4D. Moreover, an adhesive glue is disposed at the bottoms 201, 201′ of the two VCMs 20, 20′ and the engagement surface 31 of the adaptor 30 to form an adhesive layer 60. Preferably, the adhesive glue is applied by coating on the bottoms 201, 201′ of the two VCMs 20, 20′ and the engagement surface 31 of the adaptor 30.

As such, regardless of the tolerance of each component and the tolerance stack up of the assembled VCM 20, 20′, the first embodiment of the adjustment method for dual-lens structure with mechanic zero tilt angle of the present invention can adjust the first and the second tilt angles θ1, θ2 to 0°, so that the optical axes 11, 11′ of the two lenses are accurately perpendicular to the reference plane 32 of the adaptor 30 and the optical axes 11, 11′ of two lenses are accurately parallel to the normal 321 of the reference plane 32 of the adaptor 30 to obtain the first embodiment of a dual-lens structure with mechanic zero tilt angle, as shown in FIG. 5 and FIG. 6. At this point, the reference plane 32 of the adaptor 30 is engaged to an image sensor 2, the normal 321 of the reference plane 32 of the adaptor 30 overlaps the axis 2A of the image sensor 2 so that the optical axes 11, 11′ of the two lenses are parallel to the axis 2A of the image sensor 2. As such, the present invention can achieve the object of reducing the tilt angles between the optical axes 11, 11′ of the two lenses and the axis 2A of the image sensor to 0°, which improves the imaging quality of the image sensor. The adjustment method is simple, efficient and low cost.

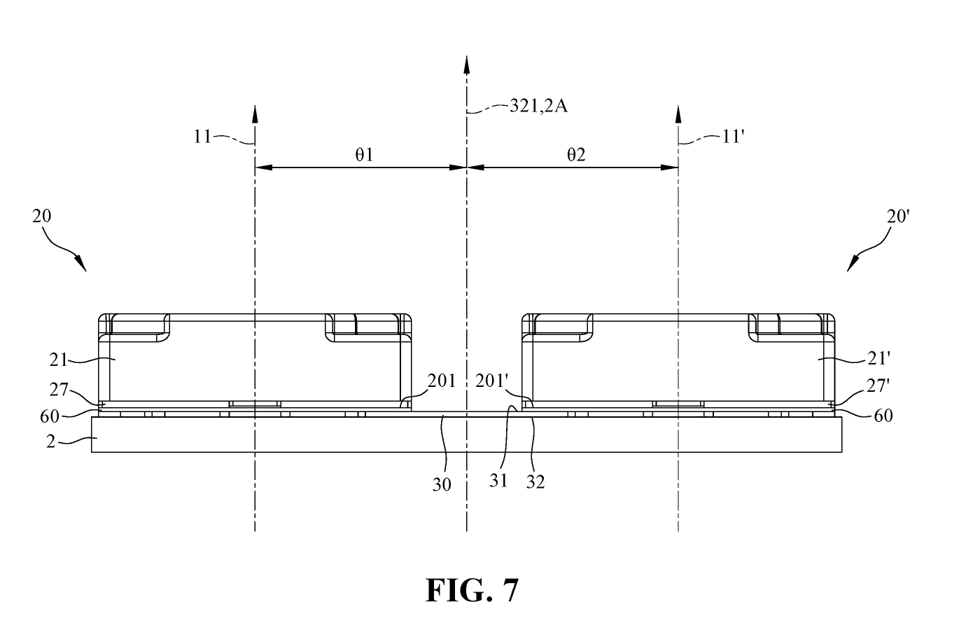

Refer to FIGS. 5-7. FIG. 5 shows a schematic view of the first embodiment of the dual-lens structure with mechanic zero tilt angle of the present invention; FIG. 6 shows a dissected view of the first embodiment of the dual-lens structure with mechanic zero tilt angle of the present invention; and FIG. 7 shows a schematic view of an image sensor engaged to the first embodiment of the dual-lens structure with mechanic zero tilt angle of the present invention. The first embodiment of the dual-lens structure with mechanic zero tilt angle of the present invention comprises: two lenses (not shown), two voice coil motors (VCM) 20, 20′, an adaptor 30 and an adhesive layer 60.

Each of the two lenses has an optical axis 11, 11′.

Each of the two VCMs 20, 20′ has a bottom 201, 201′, and the two lenses are disposed at the two VCMs 20, 20′, respectively. Specifically, each VCM 20, 20′ comprises an outer cover 21, 21′, an upper resilient stripe 22, 22′, four magnets 23, 23′, a coil 24, 24′, a base 25, 25′, a lower resilient stripe 26, 26′ and a lower cover 27, 27′. The bottom of the lower cover 27, 27′ is defined as the bottom 201, 201′ of the VCM 20, 20′, as shown in FIG. 5 and FIG. 6. Because the VCM 20, 20′ and the components are of known technology, the connection and function of the components will not be described here.

The adaptor 30 has an engagement surface 31 and a reference plane 32. The adhesive layer 60 is disposed between the bottoms 201, 201′ of the two VCMs 20, 20′ and the engagement surface 31 of the adaptor 30 so that the bottoms 201, 201′ of the two VCMs 20, 20′ are fixed to the engagement surface 31 of the adaptor 30; wherein the optical axes 11, 11′ of the two lenses are perpendicular to the reference plane 32 of the adaptor 30 respectively. In other words, the optical axes 11, 11′ of the two lenses are parallel to the normal 321 of the reference plane 32 of the adaptor 30. Therefore, the first and the second tilt angles θ1, 02 between the optical axes 11, 11′ of the two lenses and the normal 321 of the reference plane 32 of the adaptor 30 are 0°.

As such, regardless of the tolerance of each component and the tolerance stack up of the assembled VCM 20, 20′, the first embodiment of the dual-lens structure with mechanic zero tilt angle of the present invention makes the optical axes 11, 11′ of the two lenses to become accurately perpendicular to the reference plane 32 of the adaptor 30 and the optical axes 11, 11′ of two lenses are accurately parallel to the normal 321 of the reference plane 32 of the adaptor 30, and the first and the second tilt angles θ1, 02 between the optical axes 11, 11′ of the two lenses and the normal 321 of the reference plane 32 of the adaptor 30 are 0°. When the reference plane 32 of the adaptor 30 is engaged to an image sensor 2, the normal 321 of the reference plane 32 of the adaptor 30 overlaps the axis 2A of the image sensor 2 so that the optical axes 11, 11′ of the two lenses are parallel to the axis 2A of the image sensor 2, as shown in FIG. 7. As such, the present invention can achieve the object of the tilt angles between the optical axes 11, 11′ of the two lenses and the axis 2A of the image sensor being 0°, which improves the imaging quality of the image sensor. The structure is simple and low in cost.

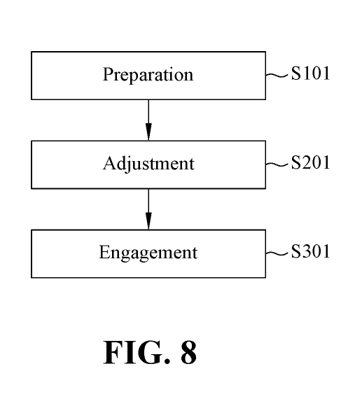

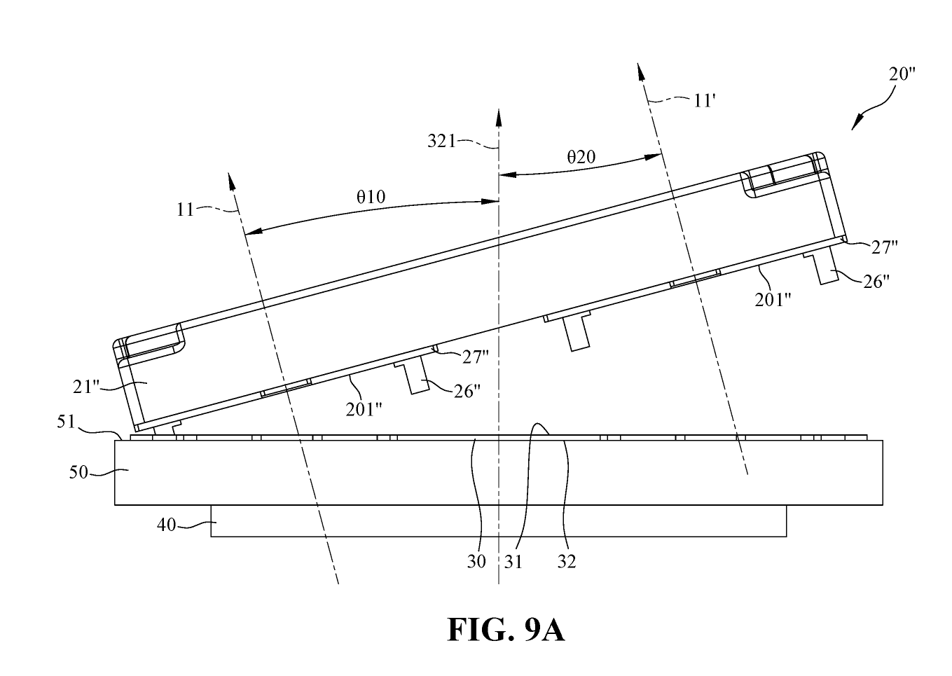

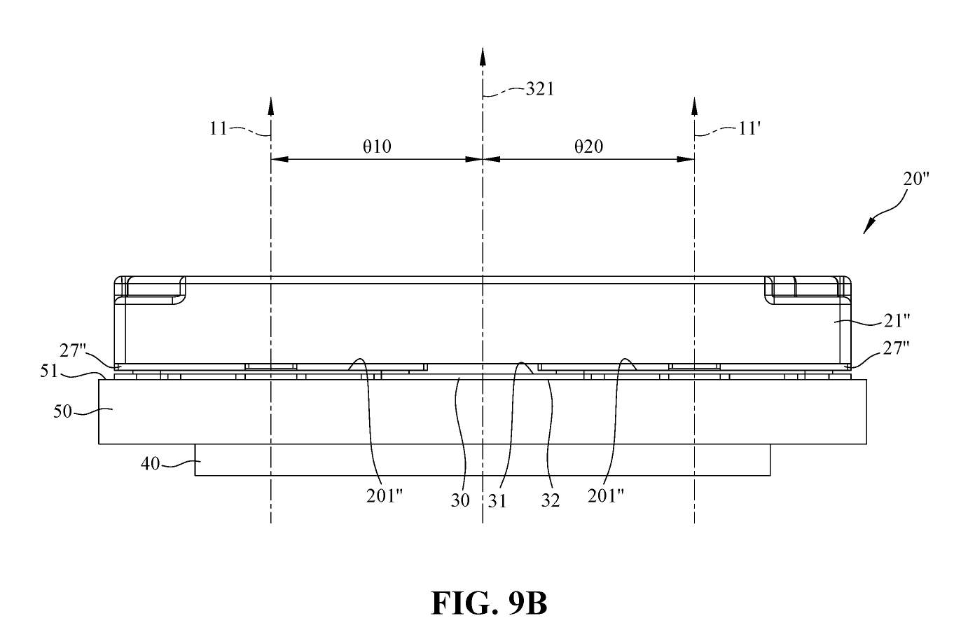

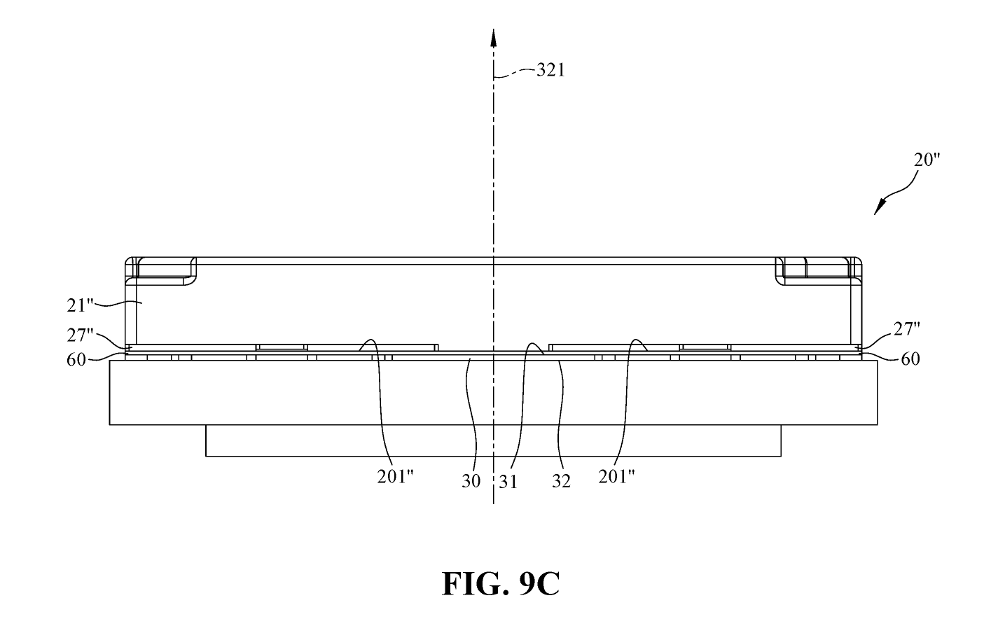

Refer to FIG. 8 and FIGS. 9A-9C. FIG. 8 shows a schematic view of the flowchart of the second embodiment of the adjustment method for dual-lens structure with mechanic zero tilt angle of the present invention; FIG. 9A shows a schematic view of the preparation step of the second embodiment of the adjustment method for dual-lens structure with mechanic zero tilt angle of the present invention; FIG. 9B shows a schematic view of the adjustment step of the second embodiment of the adjustment method for dual-lens structure with mechanic zero tilt angle of the present invention; and FIG. 9CD shows a schematic view of the engagement step of the second embodiment of the adjustment method for dual-lens structure with mechanic zero tilt angle of the present invention. The second embodiment of the adjustment method for dual-lens structure with mechanic zero tilt angle comprises the steps of:

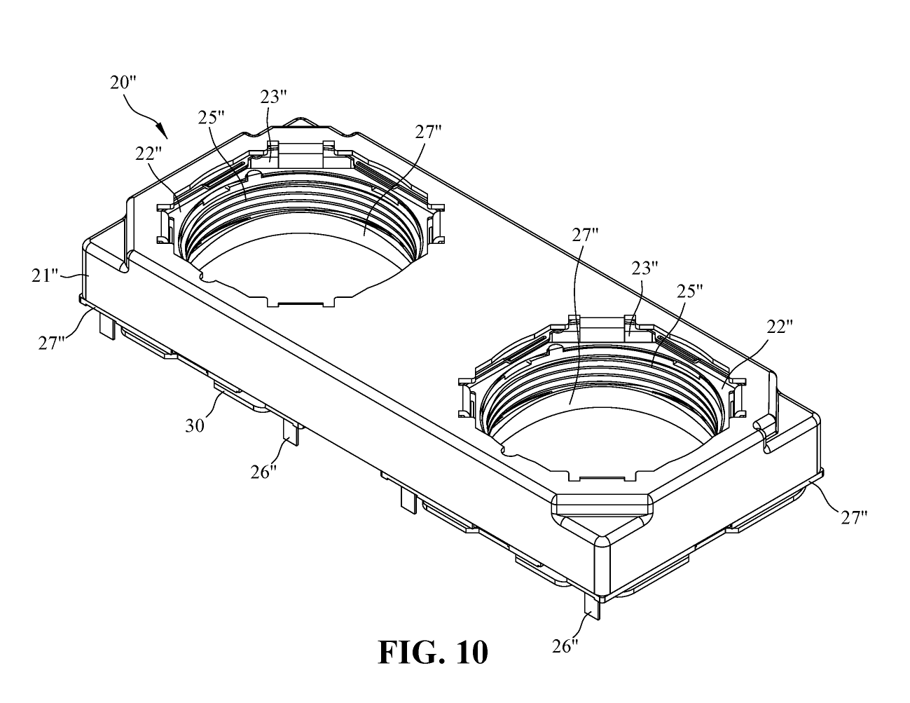

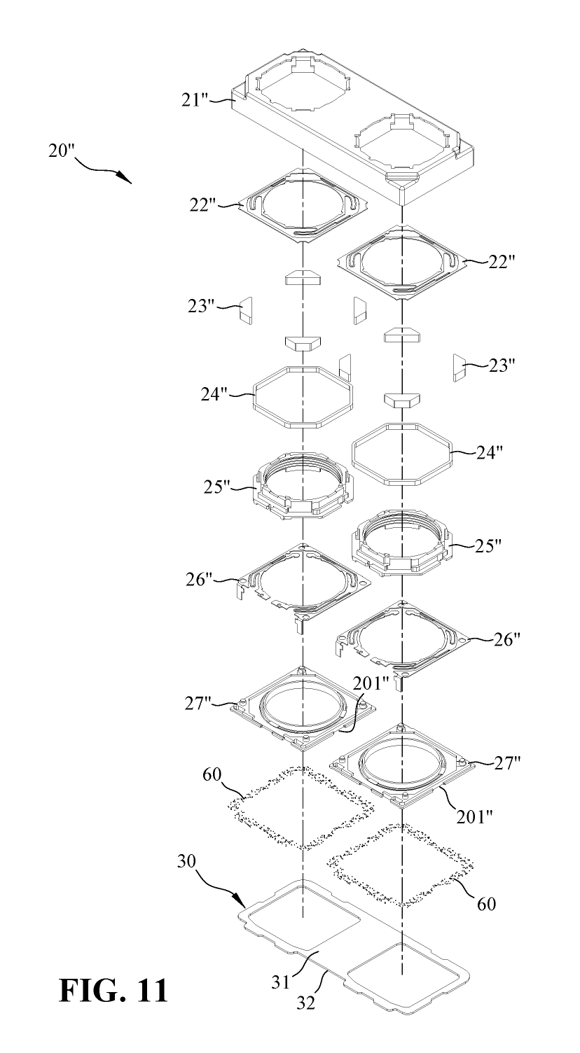

Preparation S101: disposing two lenses (not shown) of the dual-lens structure at a voice coil motor (VCM) 20″, with a bottom surface 201″ of the VCM 20″ maintaining a distance to an engagement surface 31 of an adaptor 30, the two optical axes 11, 11′ of the two lenses being parallel to each other and unparallel to the normal 321 of a reference plane 32 of the adaptor 30 so that the optical axes 11, 11′ forming a first and second tilt angles θ10, θ20 with the normal 321 of the reference plane 32 of the adaptor 30, as shown in FIG. 8 and FIG. 9A. Specifically, the VCM 20″ comprises an outer cover 21″, an upper resilient stripe 22″, four magnets 23″, a coil 24″, a base 25″, a lower resilient stripe 26″, and a lower cover 27″. The bottom of the lower cover 27″ is defined as the bottom 201″ of the VCM 20″, as shown in FIG. 10 and FIG. 11. Because the VCM 20″ and the components are of known technology, the connection and function of the components will not be described here.

Adjustment S201: moving the VCMs 20″ and/or the adaptor 30 to adjust the first and second tilt angles θ10, θ20 to 0°; when the first and second tilt angles θ10, θ20 being adjusted to 0°, the optical axes 11, 11′ of the two lenses being perpendicular to the reference plane 32 of the adaptor 30 and the VCM 20″ and/or the adaptor 30 stopping moving, as shown in FIG. 8, and FIG. 9B. In other words, the first and second tilt angles θ10, θ20 being 0° means that the optical axes 11, 11′ of the two lenses are parallel to the normal 321 of the reference plane 32 of the adaptor 30. The moving refers to the motion in the six degrees of freedom in the three dimensional space, that is, an object moving along the X-axis, Y-axis and Z-axis, and rotating around the X-axis, Y-axis and Z-axis. Accordingly, in this step, the VCM 20″ and/or the adaptor 30 moves along the X-axis, Y-axis and Z-axis, and rotates around the X-axis, Y-axis and Z-axis so as to adjust the first and second tilt angles θ10, θ20. Preferably, a sensor 40 is used for sensing the first and the second tilt angles θ10, θ20; when the sensor 40 sensing that the first and the second tilt angles θ10, θ20 becoming 0° (i.e., the optical axes 11, 11′ of the two lenses are perpendicular to the reference plane 32 of the adaptor 30, and the optical axes 11, 11′ of the two lenses are parallel to the normal 321 of the reference plane 32 of the adaptor 30), the sensor 40 will propagate the sensing result to a control device (not shown), and the control device will control the VCM 20″ and/or the adaptor 30 to stop moving. As such, the optical axes 11, 11′ of the two lenses maintains in a state of being perpendicular to the reference plane 32 of the adaptor 30. In the present embodiment, the adaptor 30 is disposed on a surface 51 of a work table 50, with a mechanical arm (not shown) moving the VCM 20 and the sensor 40 disposed at the work table 50; and when the sensor 40 sensing that the first and the second tilt angles θ10, θ20 becoming 0° (i.e., the optical axes 11, 11′ of the two lenses are perpendicular to the reference plane 32 of the adaptor 30, and the optical axes 11, 11′ of the two lenses are parallel to the normal 321 of the reference plane 32 of the adaptor 30), the sensor 40 will propagate the sensing result to a control device, and the control device will control the mechanical arm to stop moving the VCM 20″. In other embodiments, the VCM 20″ is disposed on a surface 51 of a work table 50, with a mechanical arm (not shown) moving the adaptor 30 and the sensor 40 disposed at the work table 50; and when the sensor 40 sensing that the first and the second tilt angles θ10, θ20 becoming 0° (i.e., the optical axes 11, 11′ of the two lenses are perpendicular to the reference plane 32 of the adaptor 30, and the optical axes 11, 11′ of the two lenses are parallel to the normal 321 of the reference plane 32 of the adaptor 30), the sensor 40 will propagate the sensing result to a control device, and the control device will control the mechanical arm to stop moving the adaptor 30.

Engagement S301: adhering the bottom 201″ of the VCM 20″ to the engagement surface 31 of the adaptor 30, as shown in FIG. 8 and FIG. 9C. Moreover, an adhesive glue is disposed at the bottom 201″ of the VCM 20″ and the engagement surface 31 of the adaptor 30 to form an adhesive layer 60. Preferably, the adhesive glue is applied by coating on the bottom 201″ of the VCM 20″ and the engagement surface 31 of the adaptor 30.

As such, regardless of the tolerance of each component and the tolerance stack up of the assembled VCM 20″, the first embodiment of the adjustment method for dual-lens structure with mechanic zero tilt angle of the present invention can adjust the first and the second tilt angles θ10, θ20 to 0°, so that the optical axes 11, 11′ of the two lenses are accurately perpendicular to the reference plane 32 of the adaptor 30 and the optical axes 11, 11′ of two lenses are accurately parallel to the normal 321 of the reference plane 32 of the adaptor 30 to obtain the first embodiment of a dual-lens structure with mechanic zero tilt angle, as shown in FIG. 10 and FIG. 11. At this point, the reference plane 32 of the adaptor 30 is engaged to an image sensor 2, the normal 321 of the reference plane 32 of the adaptor 30 overlaps the axis 2A of the image sensor 2 so that the optical axes 11, 11′ of the two lenses are parallel to the axis 2A of the image sensor 2. As such, the present invention can achieve the object of reducing the tilt angles between the optical axes 11, 11′ of the two lenses and the axis 2A of the image sensor to 0°, which improves the imaging quality of the image sensor. The adjustment method is simple, efficient and low cost.

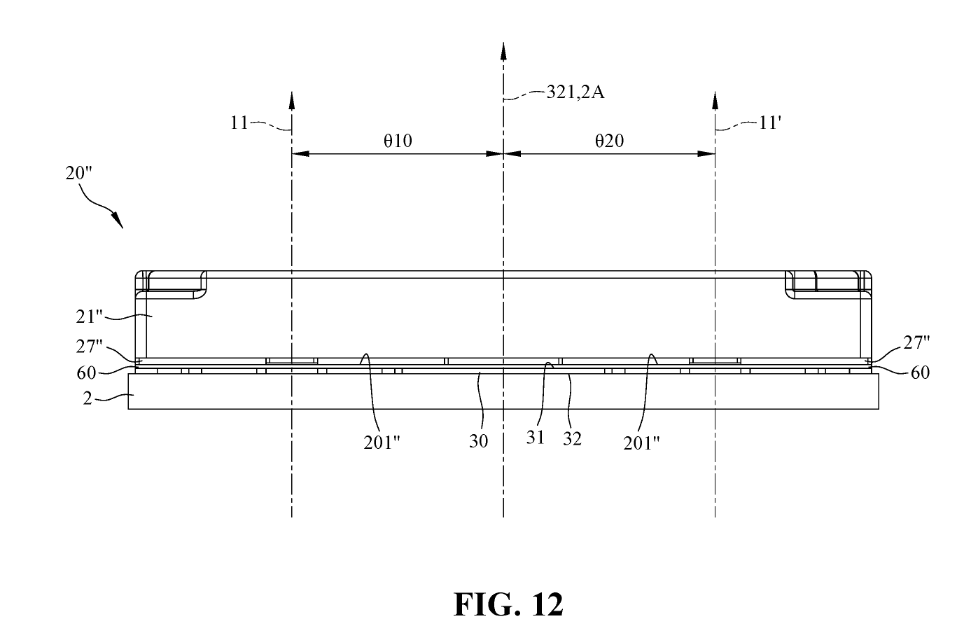

Refer to FIGS. 10-12. FIG. 10 shows a schematic view of the second embodiment of the dual-lens structure with mechanic zero tilt angle of the present invention; FIG. 11 shows a dissected view of the second embodiment of the dual-lens structure with mechanic zero tilt angle of the present invention; and FIG. 12 shows a schematic view of an image sensor engaged to the second embodiment of the dual-lens structure with mechanic zero tilt angle of the present invention. The second embodiment of the dual-lens structure with mechanic zero tilt angle of the present invention comprises: two lenses (not shown), a voice coil motors (VCM) 20″, an adaptor 30 and an adhesive layer 60.

Each of the two lenses has an optical axis 11, 11′.

The VCM 20″ has a bottom 201″, and the two lenses are disposed at the VCM 20″. Specifically, the VCM 20″ comprises an outer cover 21″, an upper resilient stripe 22″, four magnets 23″, a coil 24″, a base 25″, a lower resilient stripe 26″ and a lower cover 27″. The bottom of the lower cover 27″ is defined as the bottom 201″ of the VCM 20″.

The adaptor 30 has an engagement surface 31 and a reference plane 32. The adhesive layer 60 is disposed between the bottom 201″ of the VCM 20″ and the engagement surface 31 of the adaptor 30 so that the bottom 201″ of the VCM 20″ are fixed to the engagement surface 31 of the adaptor 30; wherein the optical axes 11, 11′ of the two lenses are perpendicular to the reference plane 32 of the adaptor 30 respectively. In other words, the optical axes 11, 11′ of the two lenses are parallel to the normal 321 of the reference plane 32 of the adaptor 30. Therefore, the first and the second tilt angles θ10, θ20 between the optical axes 11, 11′ of the two lenses and the normal 321 of the reference plane 32 of the adaptor 30 are 0°.

As such, regardless of the tolerance of each component and the tolerance stack up of the assembled VCM 20″, the first embodiment of the dual-lens structure with mechanic zero tilt angle of the present invention makes the optical axes 11, 11′ of the two lenses to become accurately perpendicular to the reference plane 32 of the adaptor 30 and the optical axes 11, 11′ of two lenses are accurately parallel to the normal 321 of the reference plane 32 of the adaptor 30, and the first and the second tilt angles θ1, 02 between the optical axes 11, 11′ of the two lenses and the normal 321 of the reference plane 32 of the adaptor 30 are 0°. When the reference plane 32 of the adaptor 30 is engaged to an image sensor 2, the normal 321 of the reference plane 32 of the adaptor 30 overlaps the axis 2A of the image sensor 2 so that the optical axes 11, 11′ of the two lenses are parallel to the axis 2A of the image sensor 2, as shown in FIG. 12. As such, the present invention can achieve the object of the tilt angles between the optical axes 11, 11′ of the two lenses and the axis 2A of the image sensor being 0°, which improves the imaging quality of the image sensor. The structure is simple and low in cost.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An adjustment method for dual-lens structure with mechanic zero tilt angle, comprising the steps of:
a preparation step: disposing two lenses of the dual-lens structure respectively at two voice coil motors (VCM), with bottom surfaces of the two VCMs maintaining a distance to an engagement surface of an adaptor, the two optical axes of the two lenses unparallel to each other and the normal of a reference plane of the adaptor so that the optical axes forming a first and second tilt angles with the normal of the reference plane of the adaptor;
an adjustment step: moving at least one of the two VCMs and the adaptor to adjust the first and second tilt angles to 0°, the optical axes of the two lenses being perpendicular to the reference plane of the adaptor and the at least one of the two VCMs and the adaptor stopping moving; and
an engagement step: adhering the bottoms of the VCMs to the engagement surface of the adaptor.

2. The adjustment method for dual-lens structure with mechanic zero tilt angle as claimed in claim 1, wherein the adjustment step comprises:
a first adjustment: moving one of the VCMs to make the optical axes of the two lenses parallel; and
a second adjustment: moving the two VCMs simultaneously to adjust the first and the second tilt angles to 0°.

3. The adjustment method for dual-lens structure with mechanic zero tilt angle as claimed in claim 1, wherein a sensor is used for sensing the first and the second tilt angles; when the sensor sensing that the first and the second tilt angles becoming 0°, the at least one of the two VCMs and the adaptor stops moving.

4. The adjustment method for dual-lens structure with mechanic zero tilt angle as claimed in claim 3, wherein the adaptor is disposed on a surface of a work table, with two mechanical arms moving the two VCMs and the sensor disposed at the work table; and when the sensor sensing that the first and the second tilt angles becoming 0°, the two mechanical arms stop moving the two VCMs.

5. The adjustment method for dual-lens structure with mechanic zero tilt angle as claimed in claim 1, wherein an adhesive glue is disposed at the bottoms of the two VCMs and the engagement surface of the adaptor to form an adhesive layer.

6. The adjustment method for dual-lens structure with mechanic zero tilt angle as claimed in claim 5, wherein the adhesive glue is applied by coating on the bottoms of the two VCMs and the engagement surface of the adaptor.

7. An adjustment method for dual-lens structure with mechanic zero tilt angle, comprising the steps of:
a preparation step: disposing two lenses of the dual-lens structure at a voice coil motor (VCM), with a bottom surface of the VCM maintaining a distance to an engagement surface of an adaptor, the two optical axes of the two lenses being parallel to each other but unparallel to the normal of a reference plane of the adaptor so that the optical axes forming a first and second tilt angles with the normal of the reference plane of the adaptor;
an adjustment step: moving the VCM and/or the adaptor to adjust the first and second tilt angles to 0°, the optical axes of the two lenses being perpendicular to the reference plane of the adaptor and the VCM and/or the adaptor stopping moving; and
an engagement step: adhering the bottom of the VCM to the engagement surface of the adaptor.

8. The adjustment method for dual-lens structure with mechanic zero tilt angle as claimed in claim 7, wherein a sensor is used for sensing the first and the second tilt angles; when the sensor sensing that the first and the second tilt angles becoming 0°, the VCM and/or the adaptor stops moving.

9. The adjustment method for dual-lens structure with mechanic zero tilt angle as claimed in claim 8, wherein the adaptor is disposed on a surface of a work table, with a mechanical arm moving the VCM and the sensor disposed at the work table; and when the sensor sensing that the first and the second tilt angles becoming 0°, the mechanical arm stops moving the VCM.

10. The adjustment method for dual-lens structure with mechanic zero tilt angle as claimed in claim 8, wherein the adaptor is disposed on a surface of a work table, with a mechanical arm moving the adaptor and the sensor disposed at the work table; and when the sensor sensing that the first and the second tilt angles becoming 0°, the mechanical arm stops moving the adaptor.

11. The adjustment method for dual-lens structure with mechanic zero tilt angle as claimed in claim 8, wherein an adhesive glue is disposed at the bottom of the VCM and the engagement surface of the adaptor to form an adhesive layer.

12. The adjustment method for dual-lens structure with mechanic zero tilt angle as claimed in claim 7, wherein the adhesive glue is applied by coating on the bottom of the VCM and the engagement surface of the adaptor.

13. A dual-lens structure with mechanic zero tilt angle, comprising:
two lenses, with each of the two lenses having an optical axis;
two voice coil motors (VCM), each of the two VCMs having a bottom, and the two lenses being disposed at the two VCMs respectively; and
an adaptor, having an engagement surface and a reference plane, with the bottoms of the two VCMs engaged respectively to the engagement surface of the adaptor, and the optical axes of the two lenses being perpendicular to the reference plane of the adaptor respectively.

14. The dual-lens structure with mechanic zero tilt angle as claimed in claim 13, wherein the dual-lens structure further comprises an adhesive layer, disposed between the bottoms of the two VCMs and the engagement surface of the adaptor.

15. A dual-lens structure with mechanic zero tilt angle, comprising:
two lenses, with each of the two lenses having an optical axis;
a voice coil motor (VCM), having a bottom, and the two lenses being disposed at the VCM; and
an adaptor, having an engagement surface and a reference plane, with the bottom of the VCM engaged to the engagement surface of the adaptor, and the optical axes of the two lenses being perpendicular to the reference plane of the adaptor respectively.

16. The dual-lens structure with mechanic zero tilt angle as claimed in claim 15, wherein the dual-lens structure further comprises an adhesive layer, disposed between the bottom of the VCM and the engagement surface of the adaptor.
